(19) United States
(12) Patent Application Publication
(10) Pub. No.: US 2013/0269888 A1
(43) Pub. Date: Oct. 17, 2013

(54) SPINDLE COVER

(71) Applicant: Carmelo Joseph Licciardi Di Stefano, Broadmeadows VIC (AU)

(72) Inventor: Carmelo Joseph Licciardi Di Stefano, Broadmeadows VIC (AU)

(21) Appl. No.: 13/860,295

(22) Filed: Apr. 10, 2013

(30) Foreign Application Priority Data
Apr. 16, 2012 (AU) 2012 100444

(51) Int. Cl. E06B 9/24

(52) U.S. Cl. CPC E06B 9/24
USPC 160/340

(57) ABSTRACT

A cord winder spindle cover housing, wherein the housing is mountable onto a spindle, and said housing has (i) a drive portion for receiving a cord that controls the extension and retraction of a blind and (ii) at least one opening through which the cord passes, the opening defined by at least one converging surface in the direction of the cord entering the housing towards the drive portion.

### FIELD

The present invention relates to a fitting for blind systems, and in particular, a winder spindle cover used with winders for controlling the extension and retraction of a screen of a blind system.

### BACKGROUND

A winder refers to a user-operated blind component (or fitting) that is rotatable for, for example, extending and retracting a cover or structure, such as a window blind. A winder can also be referred to as a clutch device or mechanism. Such fittings typically have a drive portion that engages a cord. The cord itself may or may not be beaded. For example, the cord may be referred to as a bead chain, which can be (but is not limited to) of a plastic or metal construction or combinations thereof). For example, the cord may be pulled in one direction to rotate the fitting in a blind extending direction, and the cord may be pulled in an opposite direction to rotate the fitting in a blind retracting direction.

During use, a user may attempt to pull the cord in various directions which may cause the blind materials and fittings to undergo significant stress as the blind is fully retracted or extended. When pulled quickly, the beads on the cord also become noisy as they impact the opening in any cord winder spindle cover which over time may cause damage or failure of the cover. Typically cords are also provided with stops which are attached to the cord at positions that represent positions immediately before the blind being fully retracted or extended. In this way, the stops impart impaction stress to the cover rather than the blind materials or fitting, and over time the cover may fail or be damaged.

It is therefore desired to address one or more of the above issues or problems.

### SUMMARY

According to the present invention, there is provided a cord winder spindle cover housing, wherein the housing is mountable onto a spindle, and said housing has (i) a drive portion for receiving a cord that controls the extension and retraction of a blind and (ii) at least one opening through which the cord passes, the opening defined by at least one converging surface in the direction of the cord entering the housing towards the drive portion.

Preferably the opening is further defined by a converging surface in the direction of the cord exiting the housing from the drive portion. There may be a substantially flat intermediate surface between the converging surfaces.

According to the present invention, there is provided a winder, including:
(i) a support member having a spindle; and
(ii) a housing mounted onto said spindle, said housing having (i) a drive portion for receiving a cord that controls the extension and retraction of a blind and (ii) at least one opening through which the cord passes, the opening defined by at least one converging surface in the direction of the cord entering the housing towards the drive portion.

Preferably, the opening is further defined by a converging surface in the direction of the cord exiting the housing from the drive portion. There may be a substantially fiat intermediate surface between the converging surfaces.

Preferably, the cord includes at least one stop having an impacting dimension less than the opening but more than the dimension defined by the converging surface downstream of the opening to stop the retraction or extension of the blind.

By having a converging surface, the cord, if beaded, presents an angle of deflection to that surface much less than the almost 90 degree angle of impact presented in conventional winder by beads to the housing. Therefore the impact stresses and associated noise are reduced which results in quieter operation, better housing integrity and longevity.

If a stop is incorporated onto the cord, the entry of the stop into the converging opening means it is stopped progressively by that surface which spreads the impact stress and results in quieter operation, better housing integrity and longevity.

### BRIEF DESCRIPTION OF THE DRAWINGS

Representative embodiments of the present invention are herein described, by way of example only, with reference to the accompanying drawings.

FIG. 1 is a front view of a winder.

FIG. 2 is a rear view of the winder of FIG. 1.

FIG. 3 is a top view of the winder of FIG. 1.

FIG. 4 is an underneath view of the winder of FIG. 1.

FIG. 5 is a left side view of the winder of FIG. 1.

FIG. 6 is a right side view of the winder of FIG. 1.

FIG. 7 is a perspective view of the winder of FIG. 1.

FIG. 8 is a perspective view of the components of the winder of FIGS. 1-7.

FIG. 9 is a side view of the winder of FIG. 8.

FIG. 10 is an underneath view of the winder of FIG. 8.

FIG. 11 is a section view along A-A of the winder of FIG. 8.

FIG. 12 is a front view of the winder cover of the winder of FIGS. 1-11.

FIG. 13 is a rear view of the winder cover of FIG. 12.

FIG. 14 is a top view of the winder cover of FIG. 12.

FIG. 15 is an underneath view of the winder cover of FIG. 12.

FIG. 16 is a left side view of the winder cover of FIG. 12.

FIG. 17 is a right side view of the winder cover of FIG. 12.

FIG. 18 is a perspective view of the winder cover of FIG. 12.

FIG. 19 is a front view of a winder.

FIG. 20 is a rear view of the winder of FIG. 19.

FIG. 21 is a top view of the winder of FIG. 19.

FIG. 22 is an underneath view of the winder of FIG. 19.

FIG. 23 is a left side view of the winder of FIG. 19.

FIG. 24 is a right side view of the winder of FIG. 19.

FIG. 25 is a perspective view of the winder of FIG. 19.

FIG. 26 is a side view of the winder of FIGS. 19-25.

FIG. 27 is an underneath view of a winder of FIG. 26.

FIG. 28 is a section view along E-E of the winder of FIG. 26.

FIG. 29 is a front view of the winder cover of the winder or FIGS. 21-28.

FIG. 30 is a rear view of the winder cover of FIG. 29.

FIG. 31 is a top view of the winder cover of FIG. 29.

FIG. 32 is an underneath view of the winder cover of FIG. 29.

FIG. 33 is a left side view of the winder cover of FIG. 29.

FIG. 34 is a right side view of the winder cover of FIG. 29.

FIG. 35 is a perspective view of the winder cover of FIG. 29.

FIG. 36 is a front view of a further winder.

FIG. 37 is a left side view of the winder of FIG. 36.

FIG. 38 is a right side view of the winder of FIG. 36.

FIG. 39 is a top view of the winder of FIG. 36.

FIG. 40 is an underneath view of the winder of FIG. 36.

FIG. 41 is a perspective view of the winder of FIG. 36.

FIG. 43 is an underneath view of the winder of FIG. 36 showing section lines B-B.

FIG. 44 is a section B-B view of the winder of FIG. 36.

FIG. 45 is a front view of the winder cover of the winder of FIGS. 36-44.

FIG. 46 is a rear view of the winder cover of FIG. 45.

FIG. 47 is a top view of the winder cover of FIG. 45.

FIG. 48 is an underneath view of the winder cover of FIG. 45.

FIG. 49 is a left side view of the winder cover of FIG. 45.

FIG. 50 is a right side view of the winder cover of FIG. 45.

FIG. 51 is a perspective view of the winder cover of FIG. 45.

FIG. 52 (a, b, c) are a front, underneath and perspective view of another winder cover.

FIG. 53 (a, b, c) are a front, underneath and perspective view of another winder cover

### DETAILED DESCRIPTION OF THE REPRESENTATIVE EMBODIMENTS

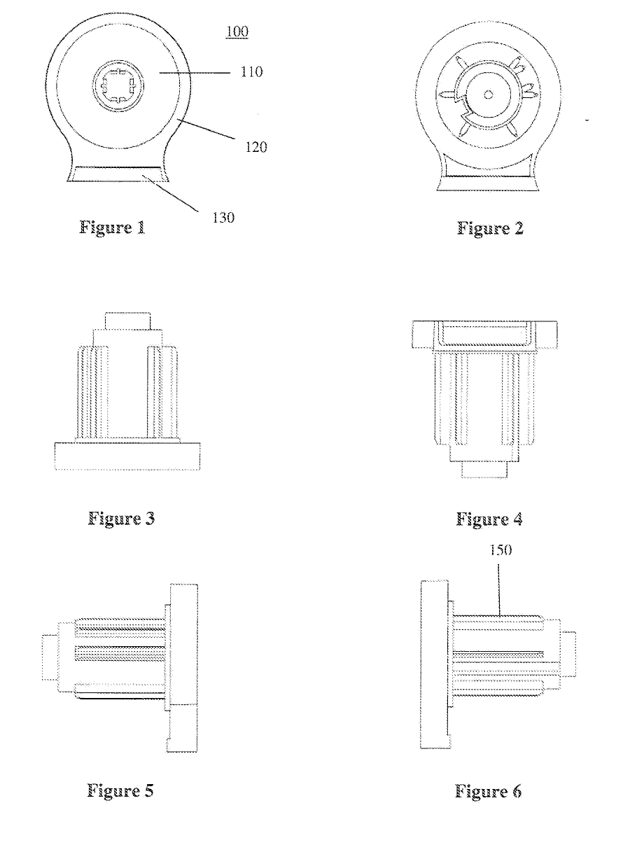

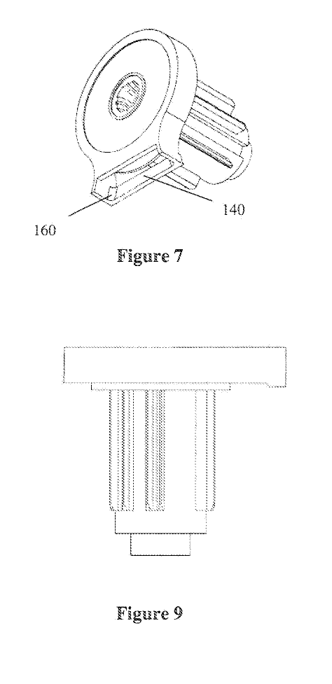

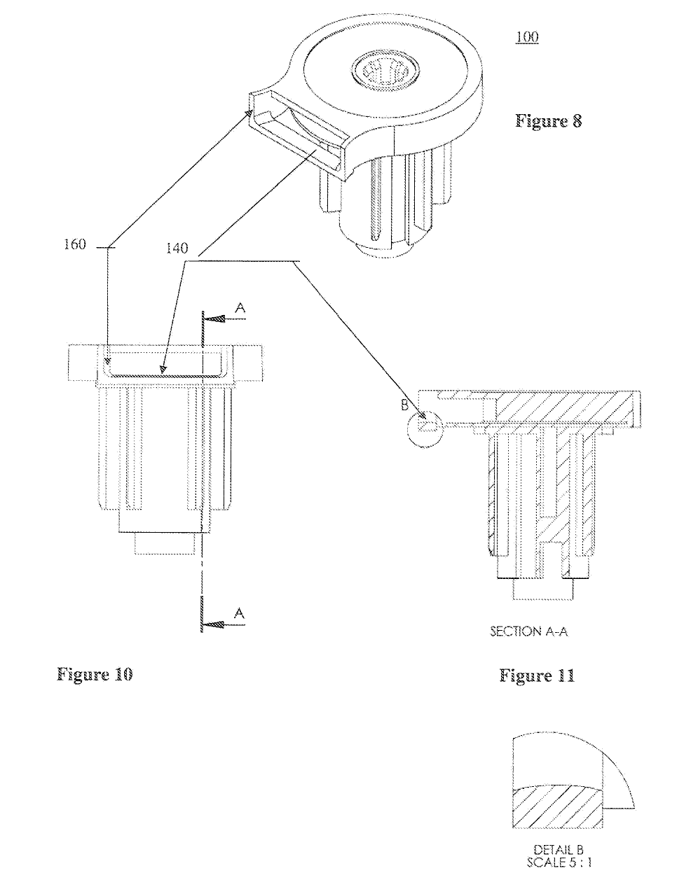

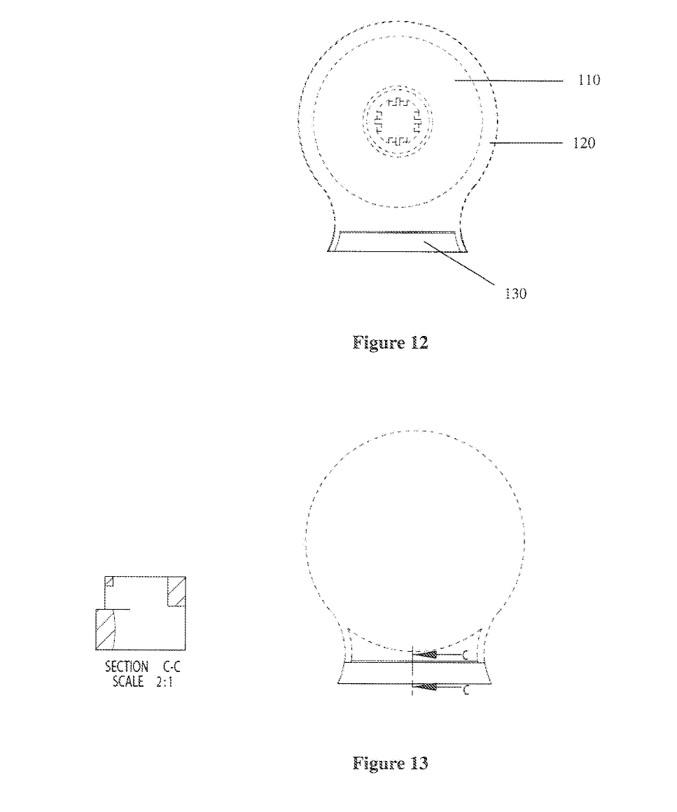

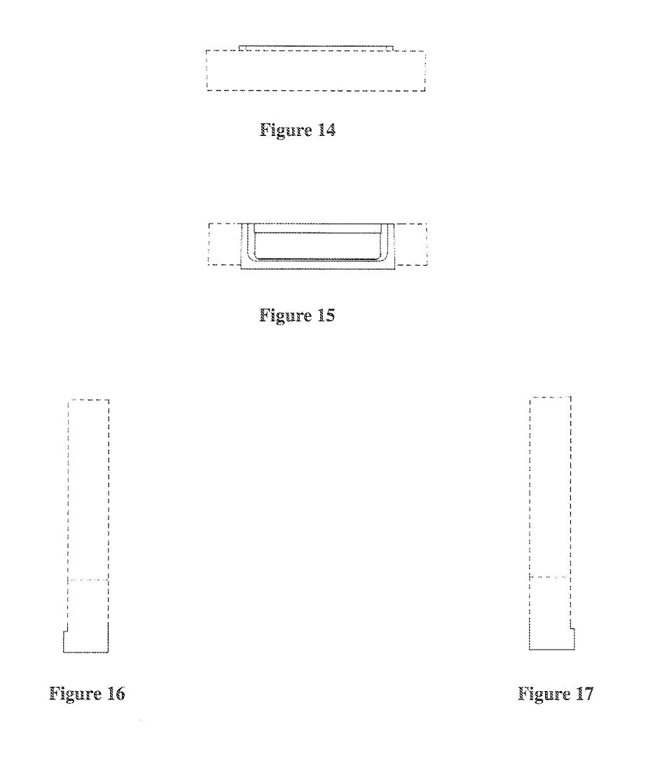

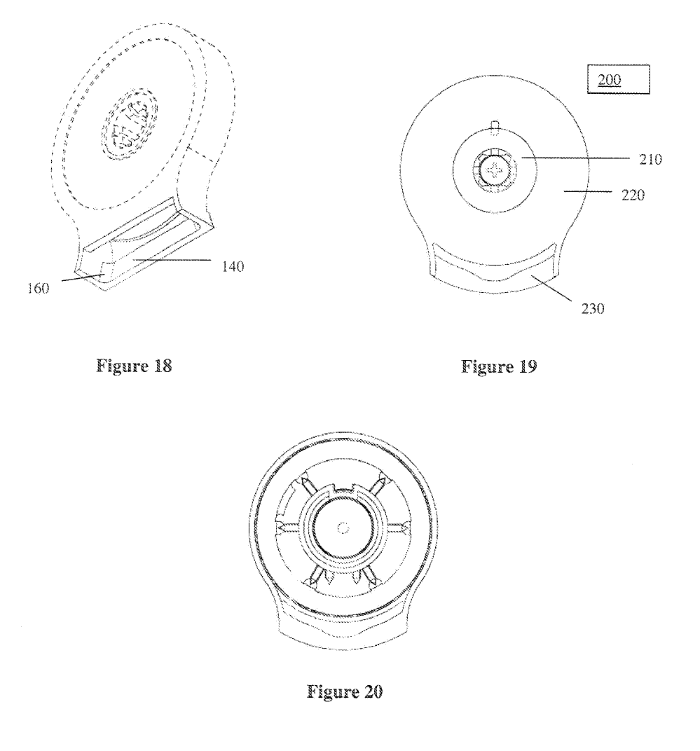

FIGS. 1-18 depict a winder 100 which is comprised of a drive 110 located in a cord cover 120 (see in particular FIGS. 14-18). A cord (not shown) passes through opening 130 and around the drive 110 (usually a wheel type member) and then out of the opening 130. By pulling the cord through the opening 130, the drive 110 is caused to rotate which in turn rotates a blind clutch 150. The blind is mounted on the blind clutch 150 at one end and also supported at its other end by a mounting (not shown).

Opening 130 is provided with a converging surface 140 (more particularly shown in FIG. 11). As the surface is angled inwardly away from the edge of the opening in a convergent fashion, the cord entering the opening 130 is not presented to a defined upstanding impact face. This means that the impact of the cord (and beads) into the opening will be minimised and therefore quieter. Similarly, less stress on the opening takes place which reduces failure of the opening materials. Opening 130 is also provided with a radius (1 mm-2 mm) in the corner between the convergent surface 140 and the side of the cover 120. This radius further facilitates the smooth operation of the cord as it moves into or out of the opening 130.

As also more particularly shown in FIG. 11, the opening may have a second converging surface which converges in the opposite direction. As such cord exits from the drive 110 it is also not presented to a defined upstanding impact face. This means that the impact of the cord (and beads) upon the opening will be minimised and therefore quieter. Similarly, less stress on the opening takes place which reduces failure of the opening materials

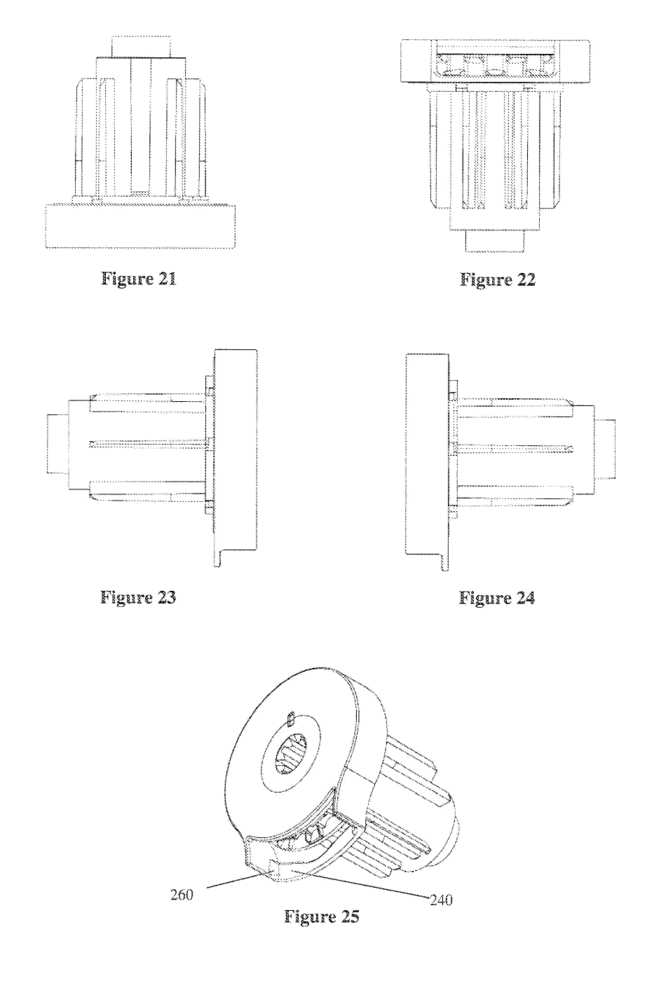

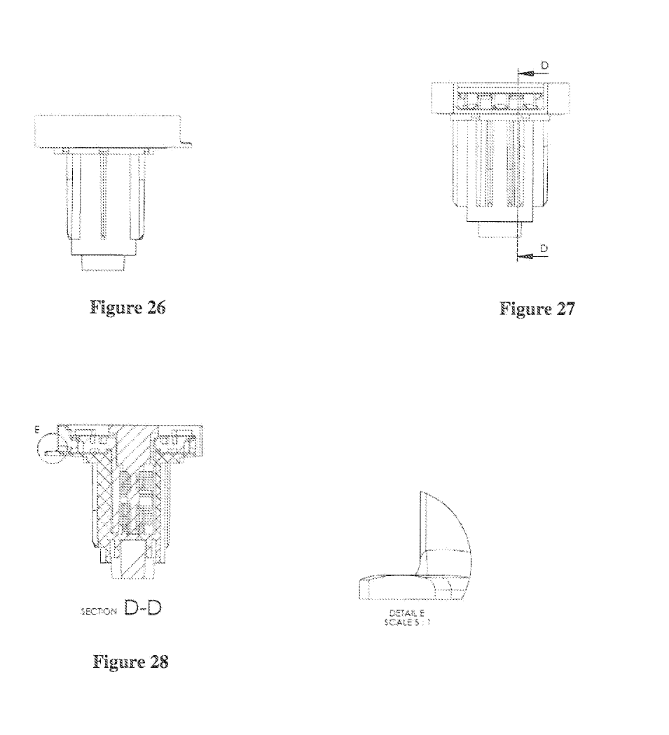

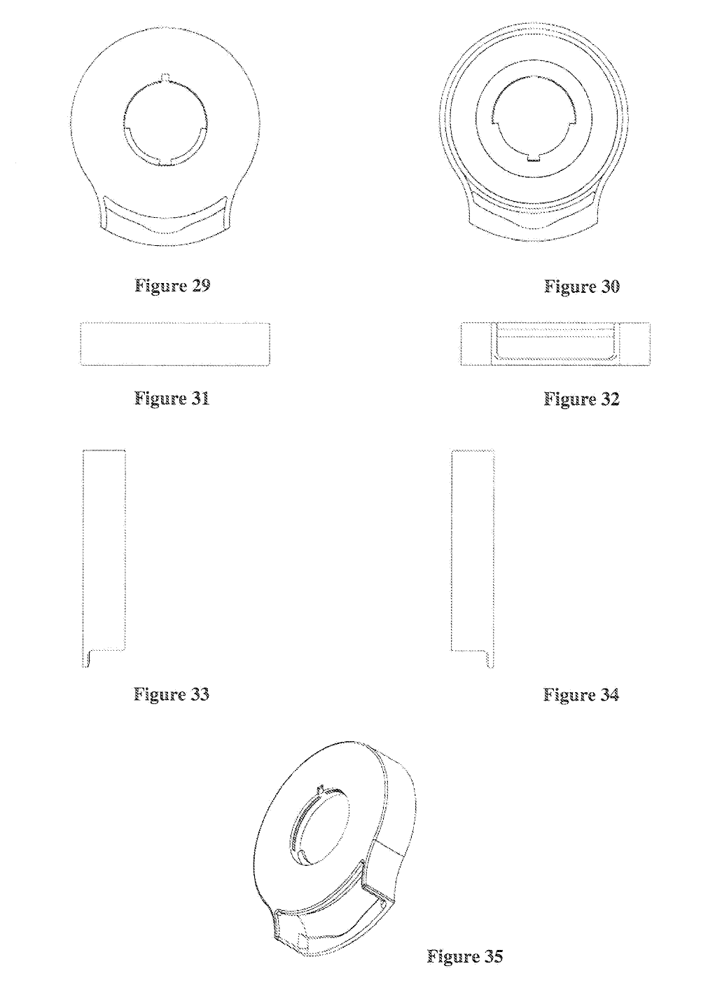

FIGS. 19-35 depict a winder 200 which is comprised of a drive 210 located in a cord cover 220 (see in particular FIGS. 29-35). A cord (not shown) passes through opening 230 and around the drive 210 (usually a wheel type member) and then out of the opening 230. By pulling the cord through the opening 230, the drive 210 is caused to rotate which in turn rotates a blind clutch 250. The blind is mounted on the blind clutch 250 at one end and also supported at its other end by a mounting (not shown).

Opening 230 is provided with a converging surface 240 (more particularly shown in FIG. 28). As the surface is angled inwardly away from the edge of the opening in a convergent fashion, the cord entering the opening 230 is not presented to a defined upstanding impact face. This means that the impact of the cord (and beads) into the opening will be minimised and therefore quieter. Similarly, less stress on the opening takes place which reduces failure of the opening materials. Opening 230 is also provided with a radius (1 mm-2 mm) in the corner between the convergent surface 240 and the side of the cover 220. This radius further facilitates the smooth operation of the cord as it moves into or out of the opening 230.

As also more particularly shown in FIG. 28, the opening may have a second converging surface which converges in the opposite direction. As such cord exits from the drive 210 it is also not presented to a defined upstanding impact face. This means that the impact of the cord (and beads) upon the opening will be minimised and therefore quieter. Similarly, less stress on the opening takes place which reduces failure of the opening materials.

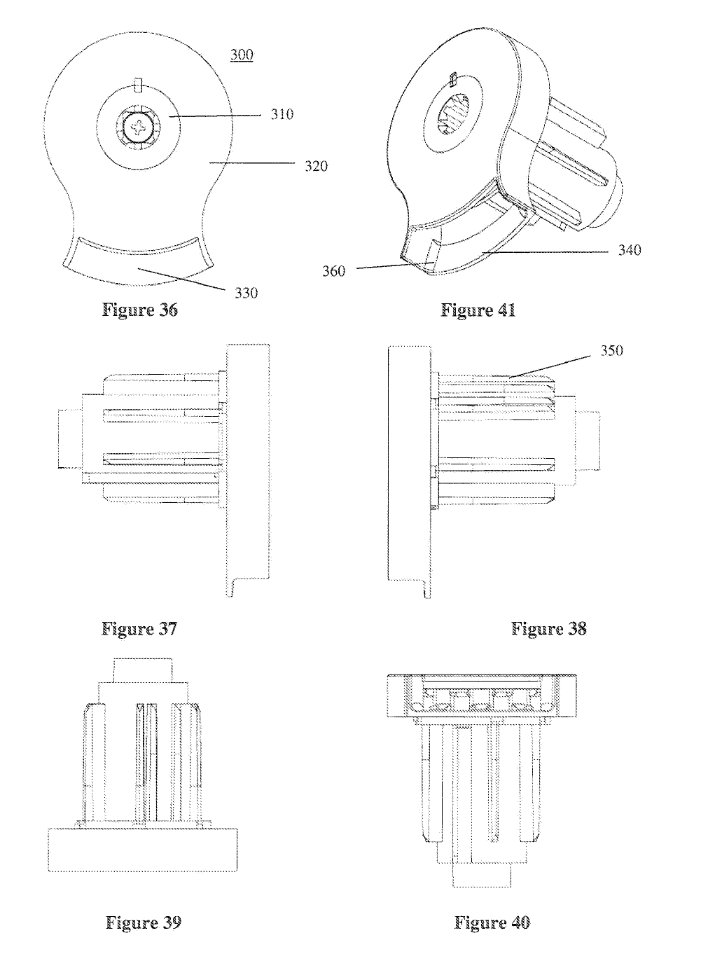

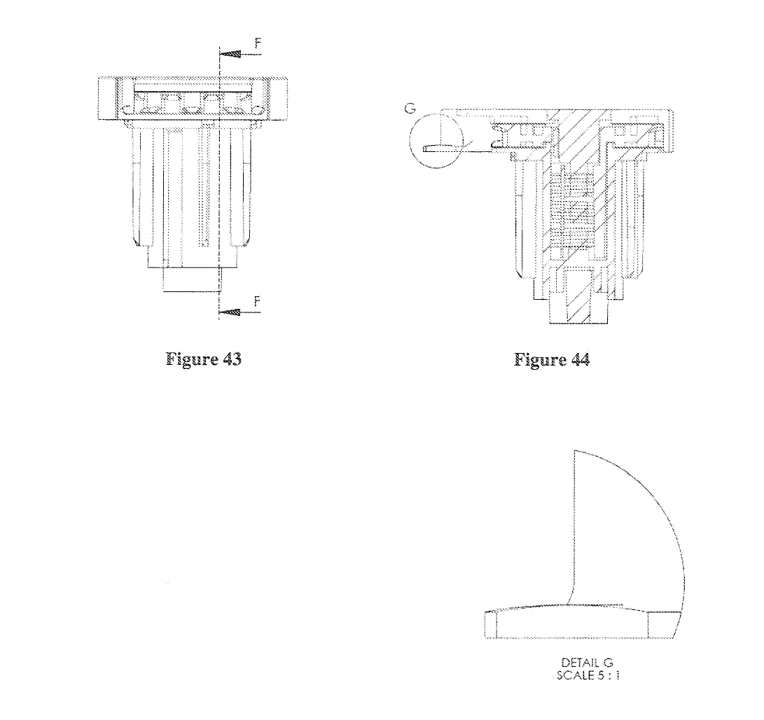

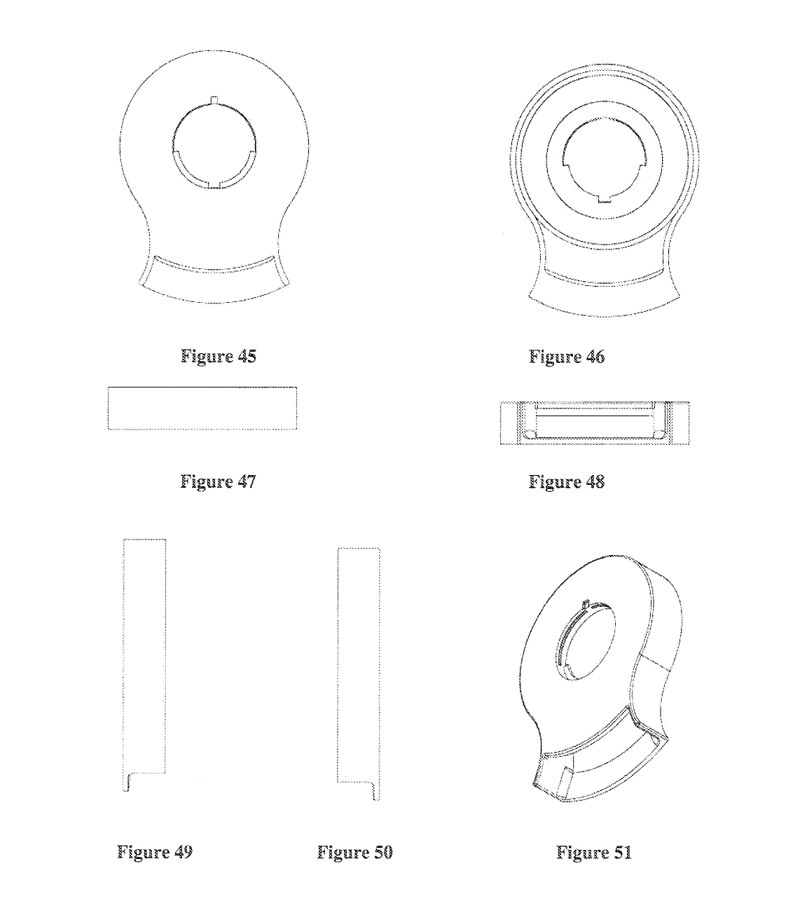

FIGS. 36-51 depict a winder 300 which is comprised of a drive 310 located in a cord cover 320 (see in particular FIGS. 45-51). A cord (not shown) passes through opening 330 and around the drive 310 (usually a wheel type member) and then out of the opening 330. By pulling the cord through the opening 330, the drive 310 is caused to rotate which in turn rotates a blind clutch 350. The blind is mounted on the blind clutch 350 at one end and also supported at its other end by a mounting (not shown).

Opening 330 is provided with a converging surface 340 (more particularly shown in FIG. 44). As the surface is angled inwardly, away from the edge of the opening in a convergent fashion, the cord entering the opening 330, is not presented to a defined upstanding impact face. This means that the impact of the cord (and beads) into the opening will be minimised and therefore quieter. Similarly, less stress on the opening takes place which reduces failure of the opening materials. Opening 330 is also provided with a radius (1 mm-2 mm) in the corner between the convergent surface 340 and the side of the cover 320. This radius further facilitates the smooth operation of the cord as it moves into or out of the opening 330.

As also more particularly shown in FIG. 44, the opening may have a second converging surface which converges in the opposite direction. As such cord exits from the drive 310 it is also not presented to a defined upstanding impact face. This means that the impact of the cord (and beads) upon the opening will be minimised and therefore quieter. Similarly, less stress on the opening takes place which reduces failure of the opening materials.

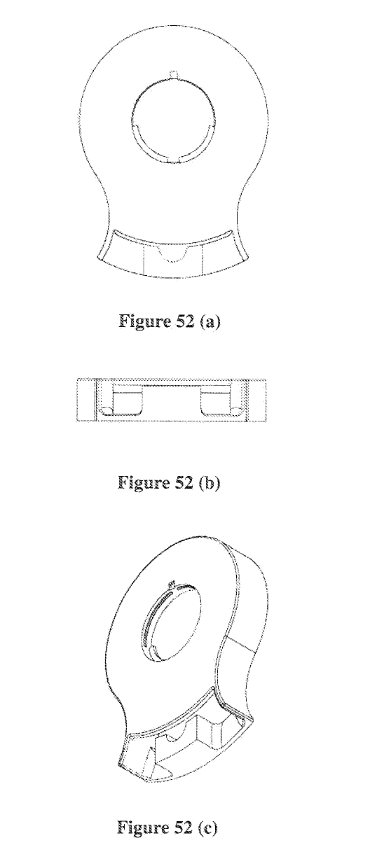

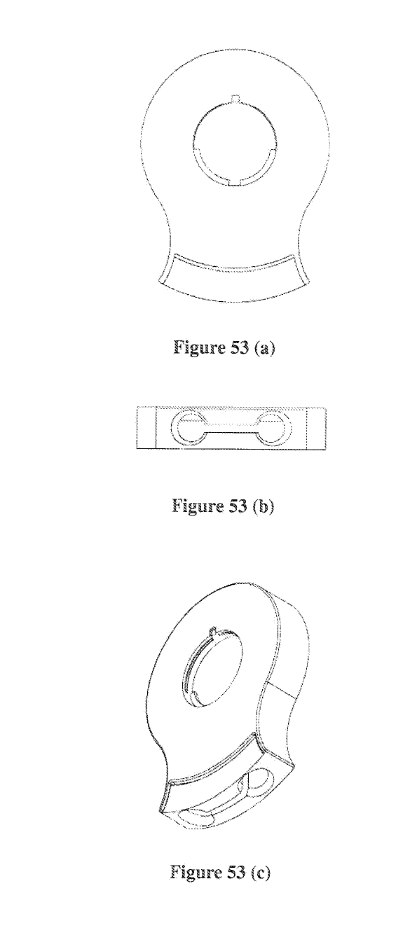

FIGS. 52 and 53 depict an alternate form of the opening which additionally separate and more clearly define the path of the cord (not shown) entering and exiting the opening. In each case the convergent surfaces as described above are also present in the areas of the opening in which the cord passes.

Modifications and improvements to the invention will be readily apparent to those skilled in the art. Such modifications and improvements are intended to be within the scope of this invention.

In this specification where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

The word ‘comprising’ and forms of the word ‘comprising’ as used in this description and in the claims does not limit the invention claimed to exclude any variants or additions.

1. A cord winder spindle cover housing, wherein the housing is mountable onto a spindle, and said housing comprising:
(i) a drive portion for receiving a cord that controls the extension and retraction of a blind and (ii) at least one opening through which the cord passes, the opening defined by at least one converging surface in the direction of the cord entering the housing towards the drive portion.

2. A cord winder spindle cover according to claim 1 wherein the opening is further defined by a converging surface in the direction of the cord exiting the housing from the drive portion.

3. A winder comprising:
(i) a support member having a spindle; and
(ii) a housing mounted onto said spindle, said housing having (i) a drive portion for receiving a cord that controls the extension and retraction of a blind and (ii) at least one opening through which the cord passes, the opening defined by at least one converging surface in the direction of the cord entering the housing towards the drive portion.

4. A winder according to claim 3 wherein the opening is further defined by a converging surface in the direction of the cord exiting the housing from the drive portion.

5. A winder according to claim 3 wherein the cord includes at least one stop having an impacting dimension less than the opening but more than the dimension defined by the converging surface downstream of the opening to stop the retraction of extension of the blind.

6. A winder according to either claim 4 wherein the cord includes at least one stop having an impacting dimension less than the opening but more than the dimension defined by the converging surface downstream of the opening to stop the retraction of extension of the blind.
